(19) United States
(12) Patent Application Publication
(10) Pub. No.: US 2009/0080075 A1
(43) Pub. Date: Mar. 26, 2009

(54) OPTICAL FILTER WITH MOTH-EYE GRATING STRUCTURE

(75) Inventors: YU-LUN HO, Tu-Cheng (TW); I-PEN CHIEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/959,239

(22) Filed: Dec. 18, 2007

(30) Foreign Application Priority Data
Sep. 24, 2007 (CN) 200710201833.4

(51) Int. Cl. G02B 5/18

(52) U.S. Cl. 359/569; 359/558

(57) ABSTRACT

An optical element includes a transparent substrate, a filter film, and an moth-eye grating structure. The filter film and the moth-eye grating structure are formed on two facing away surfaces of the transparent substrate. The moth-eye grating structure is configured for promoting anti-reflection properties to the moth-eye grating structure.

### TECHNICAL FIELD

The present invention relates to optical filters and, particularly, to an optical filter having moth-eye grating structure with high light transmittance.

### DESCRIPTION OF RELATED ART

Optical filters are designed to transmit a specific waveband or reduce a spectral range (such as bandpass, cut off, and interference filters). They are composed of many thin layers of dielectric materials, which have different refractive indices to produce constructive and destructive interference in the transmitted light. In this way, optical filters can be used to transmit a specific waveband and cut off undesired wavelength range.

Referring to FIG. 7, a typical optical filter 100a is shown. The optical filter 100a includes a transparent substrate 10a, a filter film 20a, and an antireflection film 30a. The filter film 20a and the antireflection film 30a are formed on two facing away surfaces of the transparent substrate 10a. The filter film 20a can cut off undesired wavelength range and the antireflection film 30a can improve the light transmittance of desired wavelength range.

The antireflection film 30a is usually composed of many thin layers of dielectric materials, which have different refractive indices. The light transmittance of the desired wavelength range usually depends on the composition of the thin film filter material. Moreover, the transmittance of the antireflection film 30a is usually affected by other factors, such as temperature of environment and so on.

What is needed, therefore, is an optical filter having high transmittance in a desired wavelength range and can overcome the above problem.

### SUMMARY

In accordance with one present embodiment, an optical element includes a transparent substrate, a filter film, and an moth-eye grating structure. The filter film and the moth-eye grating structure are formed on two facing away surfaces of the transparent substrate. The moth-eye grating structure is configured for promoting anti-reflection properties to the moth-eye grating structure.

### BRIEF DESCRIPTION OF THE DRAWING

Many aspects of the present optical filter can be better understood with reference to the following drawings. The components in the drawing are not necessarily drawn to scale, the emphasis instead being placed upon clearly illustrating the principles of the present optical element. Moreover, in the drawings, like reference numerals designate corresponding parts throughout the several views.

FIG. 1 is a schematic view of an optical filter according to a first embodiment.

FIG. 2 is a cross-sectional view taken along line II-II of FIG. 1, in accordance with the first embodiment.

FIG. 3 is an amplified view of section IV of FIG. 2, in accordance with the first embodiment.

FIG. 4 is a schematic view of an optical filter according to a second embodiment.

FIG. 5 is a cross-sectional view taken along line V-V of FIG. 4, in accordance with the second embodiment.

FIG. 6 is a schematic view of an optical filter of related art.

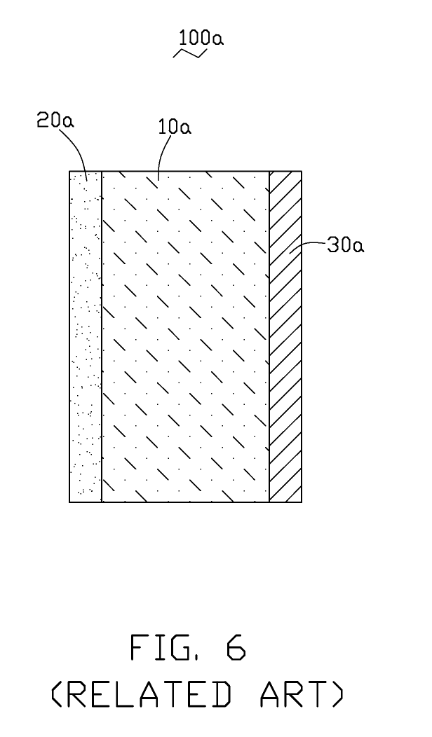

### DETAILED DESCRIPTION OF THE EMBODIMENTS

Embodiments will now be described in detail below, with reference to the drawings.

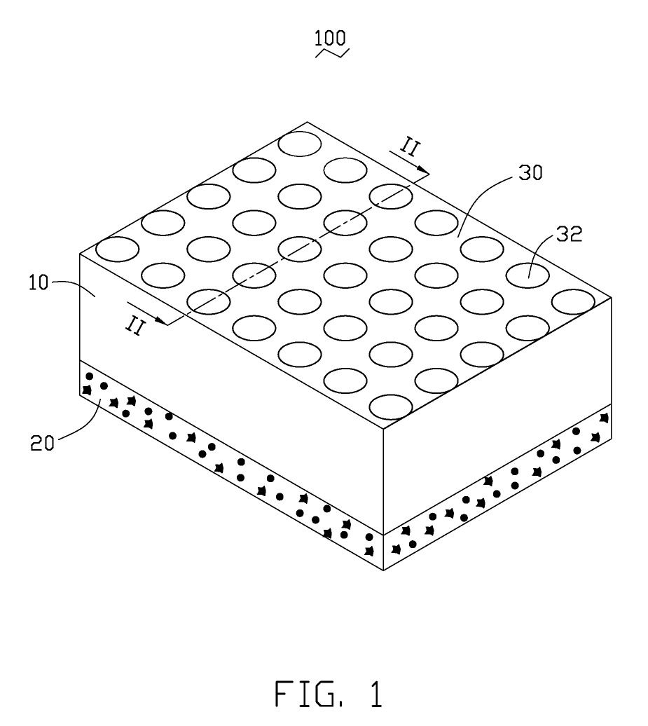

Referring to FIG. 1, an optical filter 100, according to a first embodiment, is shown. The optical filter 100 includes a transparent substrate 10, a filter film 20, and an moth-eye grating structure 30.

The material of the transparent substrate 10 can be selected from glass or plastic. The filter film 20 and the moth-eye grating structure 30 are formed on two opposite surfaces of the transparent substrate 10 respectively.

The filter film 20 is designed to transmit a specific waveband or reduce a spectral range (for use in bandpass, cut off, and interference filters for example). The filter film 20 is composed of many thin layers of dielectric materials, which have different refractive indices to produce constructive and destructive interference in the transmitted light. In this way, the filter film 20 can be used to transmit a specific waveband and cut off undesired wavelength range.

The moth-eye grating structure 30 includes an array of spaced holes 32. Sizes of the holes 32 reduce along the direction away from the transparent substrate 10. The holes 32 can be a stepped hole, a cone-shaped hole, or a hemisphere-shaped hole.

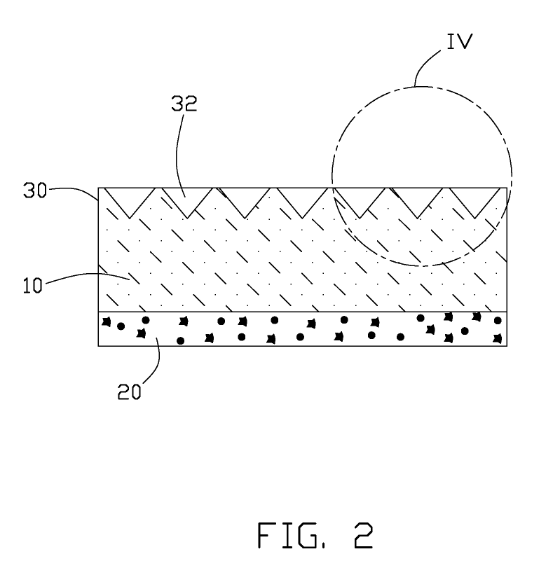

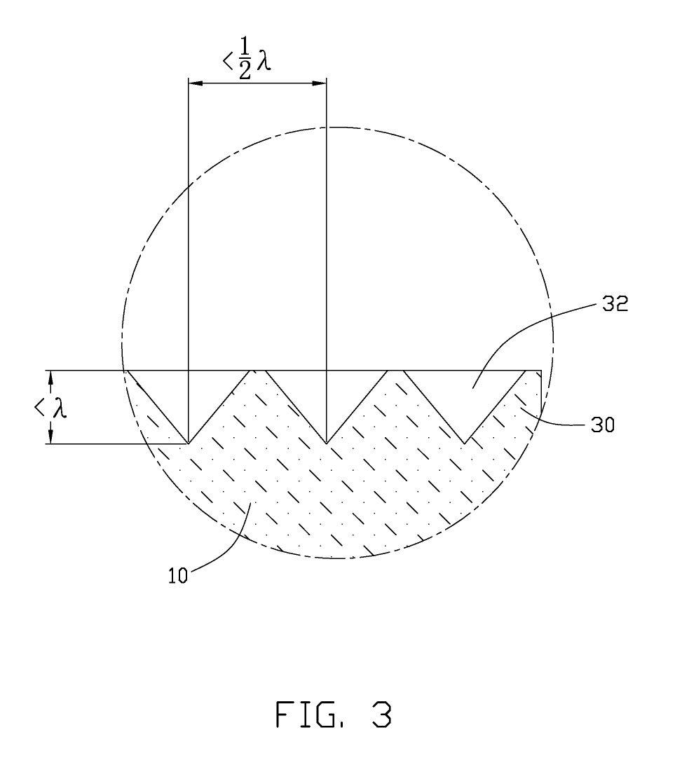

Referring to FIG. 2 and FIG. 3, in the present embodiment, the holes 32 are cone-shaped holes. The distance between two adjacent holes 32 is less than λ/2, wherein λ is a wavelength of incident light. The depth of the holes 32 is less than λ. Preferably, the λ is in a range from 500 nm to 700 nm. The moth-eye grating structure 30 provides anti-reflection properties to the optical filter 100. The principle of the moth-eye grating structure 30 is disclosed by Clapham et al., “Reduction of Lens Reflection by the “Moth Eye” Principle,” Nature, 244:281-282 (1973).

In the present embodiment, the moth-eye grating structure 30 is integrally formed with the transparent substrate 10. So that, the cost of manufacturing the optical filter 100 can be reduced. The material of the moth-eye grating structure 30 and the material of the transparent substrate 10 have a same refractive index. Preferably, the moth-eye grating structure 30 and the transparent substrate 10 are made of a same material. The moth-eye grating structure 30 and the transparent substrate 10 can be integrally formed by injection molding or press-molding. The holes 32 can be formed on the moth-eye grating structure 30 during or after process of the moth-eye grating structure 30 and the transparent substrate 10 being integrally formed. The holes 32 can be formed on the moth-eye grating structure 30 by injection molding, press-molding, or chemical etching.

Because the composition of the moth-eye grating structure 30 is uniform, the moth-eye grating structure 30 can be made easily and the transmittance of the moth-eye grating structure 30 will be effected by relatively fewer factors and to a less degree.

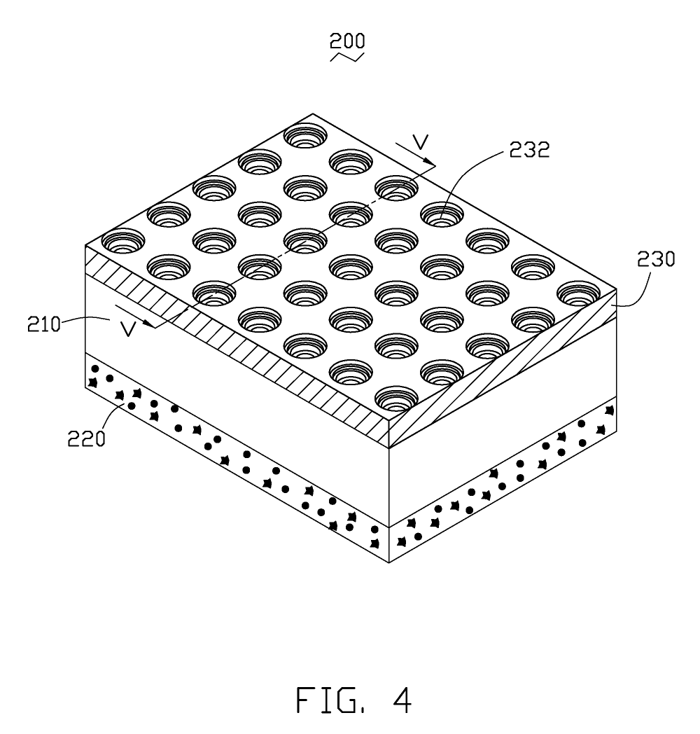

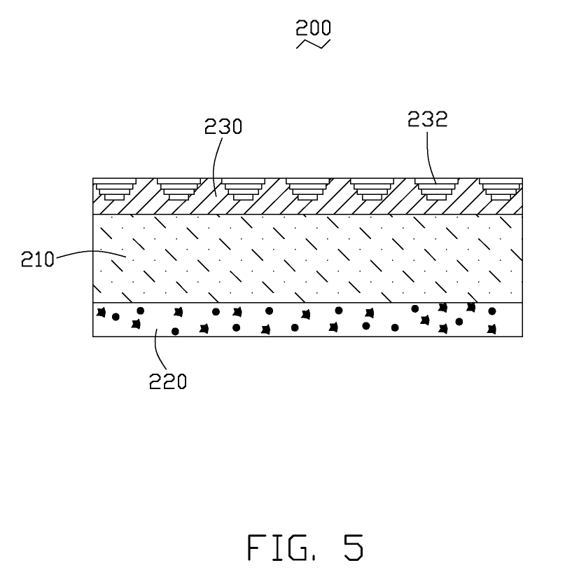

Referring to FIG. 4 and FIG. 5, an optical filter 200 according to a second embodiment includes a transparent substrate 210, a filter film 220, and an moth-eye grating structure 230. The filter film 220 and the moth-eye grating structure 230 are formed on two opposite surfaces of the transparent substrate 210 respectively. The moth-eye grating structure 230 includes an array of spaced holes 232. The differences between the optical filter 200 and the optical filter 100 is that the transparent substrate 210 and the moth-eye grating structure 230 are formed independently and the holes 232 are stepped holes.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An optical filter comprising:
a transparent substrate;
a filter film formed on a surface of the transparent substrate; and
an antireflection moth-eye grating structure formed on a surface of the transparent substrate facing away from the filter film for promoting anti-reflection of the optical element.

2. The optical filter as claimed in claim 1, wherein the material of the transparent substrate is selected from the group consisting of glass and plastic.

3. The optical filter as claimed in claim 1, wherein the moth-eye grating structure comprises an array of spaced holes.

4. The optical element as claimed in claim 1, wherein the holes is selected from a group consisting of a stepped hole, a cone-shaped hole, or a hemisphere-shaped hole.

5. The optical filter as claimed in claim 3, wherein the distance between two adjacent holes is less than λ/2, the depth of the holes is less than λ, wherein, λ is a central wavelength of incident light.

6. The optical filter as claimed in claim 4, wherein λ is in a range from 500 nm to 700 nm.

7. The optical filter as claimed in claim 1, wherein the moth-eye grating structure is integrally formed with the transparent substrate.

8. The optical filter as claimed in claim 7, wherein the moth-eye grating structure and the transparent substrate are integrally formed by injection molding or press-molding.

9. The optical filter as claimed in claim 1, wherein the material of the antireflection moth-eye grating structure and the material of the transparent substrate have a same refractive index.

10. The optical filter as claimed in claim 9, wherein the moth-eye grating structure and the transparent substrate are made of a same material.

11. The optical filter as claimed in claim 3, wherein the holes are formed on the moth-eye grating structure by injection molding, press-molding, or chemical etching.
